(19) United States
(12) Patent Application Publication
(10) Pub. No.: US 2020/0096400 A1
(43) Pub. Date: Mar. 26, 2020

(54) MATERIAL FOR PRESSURE MEASUREMENT

(71) Applicant: FUJIFILM Corporation, Tokyo (JP)

(72) Inventor: Shinya KATO, Shizuoka (JP)

(73) Assignee: FUJIFILM Corporation, Tokyo (JP)

(21) Appl. No.: 16/697,114

(22) Filed: Nov. 26, 2019

Related U.S. Application Data
(63) Continuation of application No. PCT/JP2018/018398, filed on May 11, 2018.

(30) Foreign Application Priority Data
May 31, 2017 (JP) 2017-108377

(51) Int. Cl. G01L 1/24

(52) U.S. Cl. CPC G01L 1/247

(57) ABSTRACT

A material for pressure measurement includes a first material having a color developer layer containing a microcapsule A encapsulating an electron-donating dye precursor disposed on a first base material and a second material having a developer layer containing an electron-accepting compound disposed on a second base material, the first base material contains an inorganic filler, and a proportion of the inorganic filler having a particle diameter of 0.1 μm or more in all of the inorganic filler contained in the first base material is 5% by volume or less, and an arithmetic average roughness Ra of a surface of the developer layer satisfies 0.1 μm≤Ra≤1.1 μm.

### CROSS-REFERENCE TO RELATED APPLICATION

This application is a Continuation of International Application No. PCT/JP2018/018398, filed May 11, 2018, which claims priority to Japanese Patent Application No. 2017-108377 filed May 31, 2017. Each of the above applications is hereby expressly incorporated by reference, in its entirety, into the present application.

### BACKGROUND OF THE INVENTION

### 1. Field of the Invention

The present disclosure relates to a material for pressure measurement.

### 2. Description of the Related Art

Materials for pressure measurement (that is, materials that are used for the measurement of pressure) are used in applications such as an attachment step of a glass substrate; solder printing onto a print substrate; the adjustment of pressure between rollers; and the like in the manufacturing of a liquid crystal panel.

As an example of the materials for pressure measurement, there are, for example, pressure measurement films represented by PRESCALE (trade name; registered trademark) provided by Fujifilm Corporation.

In recent years, materials for pressure measurement for measuring a fine pressure have been being studied.

For example, JP4986749B discloses, as a material for pressure measurement capable of favorably developing color in a low pressure (particularly, a pressure of 3 MPa or lower) region and capable of favorably reading concentrations, a material for pressure measurement having a plastic base material, a color developer layer including an electron-donating dye precursor, and a developer layer including an electron-accepting compound and using a color development reaction between the electron-donating dye precursor and the electron-accepting compound, in which the electron-donating dye precursor is encapsulated in a microcapsule including a urethan bond, at least one kind of substituent of the electron-accepting compound is a salicylic acid metal salt having a substituent, and the microcapsule satisfies a relationship of δ/D=1.0×10⁻³ to 2.0×10⁻² [δ: the number-average wall thickness (μm) of the microcapsule, D: the volume-standard median size (μm) of the microcapsule].

In addition, JP4986750B discloses, as a material for pressure measurement from which a concentration that can be noticed or read by a fine pressure (particularly, a pressure of lower than 0.1 MPa (preferably a surface pressure)) can be obtained and which is capable of measuring a pressure distribution with a fine pressure, a material for pressure measurement using a color development reaction between an electron-donating dye precursor encapsulated in a microcapsule and an electron-accepting compound, in which, in a case where a volume-standard median size of the microcapsule is A the number of microcapsules having a diameter of (A+5) μm or more present per 2 cm×2 cm is 7,000 to 28,000, and a color optical density difference ΔD before and after pressurization at 0.05 MPa is 0.02 or more.

In addition, JP5142640B discloses, as a material for pressure measurement for a low pressure in which color development by friction is suppressed, a material for pressure measurement using a color development reaction between an electron-donating dye precursor and an electron-accepting compound, in which a first material having a color developer layer containing a microcapsule encapsulating the electron-donating dye precursor provided on a base material and a second material having a developer layer containing the electron-accepting compound provided on a base material are included, a ratio (δ/D) of a number-average wall thickness δ of the microcapsule to a volume-standard median size D of the microcapsule is 1.0×10⁻³ or more and 2.0×10⁻² or less, and an arithmetic average roughness Ra of a surface of the developer layer is 0.1 μm or more and 1.1 μm or less.

### SUMMARY OF THE INVENTION

As shown in JP4986749B, JP4986750B, and JP5142640B described above, the materials for pressure measurement for measuring fine pressures are being studied.

However, in recent years, in a background in which an attempt is underway to attain the functional improvement and higher definition of products, there has been an intensifying need for more precisely identifying a region to which a fine pressure is applied.

For example, in the field of liquid crystal panels, there is a case where a vacuum attachment method is employed as an attachment method in order to cope with an increase in size, and, in this case, it is necessary to precisely identify a region to which a pressure of lower than 0.1 MPa (that is, atmospheric pressure) is applied.

In addition, in the field of smartphones, in response to the thickness reduction of modules, attachment at a fine pressure of 0.05 MPa or lower is required from the viewpoint of improving the yield during attachment. Therefore, in the field of smartphones, it is necessary to precisely identify a region to which a fine pressure of 0.05 MPa or lower is applied.

Under the above-described circumstances, the range of measurable pressures of commercially available pressure measurement films, that is, the ranges of pressures in which color development can be obtained by pressurization is a range of 0.05 MPa or higher. Therefore, in a case where a fine pressure of 0.05 MPa or lower is applied to a commercially available pressure measurement film, there is a case where the color optical density difference ΔD before and after pressurization is too small and the pressure cannot be accurately identified.

In the materials for pressure measurement described in JP4986749B, JP4986750B, and JP5142640B as well, the same problem as that of the commercially available pressure measurement films can be caused.

For the above-described reasons, the obtainment of a color optical density that can be read even in a case where a fine pressure of 0.05 MPa or lower is applied is demanded.

However, in a material for pressure measurement from which a color optical density that can be read even in a case where a fine pressure of 0.05 MPa or lower is applied, there is a case where unevenness in the color optical density is caused in a region to which a certain pressure is applied. The present inventors' studies clarified that this problem of the unevenness in the color optical density becomes significant in the case of using a base material containing an inorganic filler as a base material in the material for pressure measurement.

Therefore, an object of an embodiment of the present invention is to provide a material for pressure measurement from which a color optical density that can be read even in a case where a fine pressure of 0.05 MPa or lower is applied, in which unevenness in a color optical density in a region to which a certain pressure is applied is suppressed in spite of the fact that the material for pressure measurement includes a first material having a color developer layer disposed on a first base material containing an inorganic filler and a second material having a developer layer disposed on a second base material.

Specific means for achieving the above-described object includes the following aspects.
<1> A material for pressure measurement comprising:
a first material having a color developer layer containing a microcapsule A encapsulating an electron-donating dye precursor disposed on a first base material; and
a second material having a developer layer containing an electron-accepting compound disposed on a second base material,

In which the first base material contains an inorganic filler, and a proportion of the inorganic filler having a particle diameter of 0.1 μm or more in all of the inorganic filler contained in the first base material is 5% by volume or less, and
an arithmetic average roughness Ra of a surface of the developer layer satisfies 0.1 μm≤Ra≤1.1 μm.
<2> The material for pressure measurement according to <1>, in which the color developer layer is adjacent to the first base material.
<3> The material for pressure measurement according to <1> or <2>, in which a coefficient of variation of a number-based particle size distribution of particles having a particle diameter of 2 μm or larger contained in the color developer layer is 50% to 100%.
<4> The material for pressure measurement according to any one of <1> to <3>, in which at least one of the color developer layer or the developer layer contains a microcapsule B not encapsulating the electron-donating dye precursor.
<5> The material for pressure measurement according to any one of <1> to <4>, in which the color developer layer contains a microcapsule B not encapsulating the electron-donating dye precursor.
<6> The material for pressure measurement according to <4> or <5>, in which a material of a capsule wall of the microcapsule B is a melamine formaldehyde resin.
<7> The material for pressure measurement according to any one of <1> to <6>, in which a material of a capsule wall of the microcapsule A is a melamine formaldehyde resin.
<8> The material for pressure measurement according to any one of <1> to <7>, in which a color optical density difference ΔD before and after pressurization at 0.03 MPa is 0.08 or more.
<9> The material for pressure measurement according to any one of <1> to <8>, in which the proportion of the inorganic filler having a particle diameter of 0.1 μm or more in all of the inorganic filler contained in the first base material is 2% by volume or less.
<10> The material for pressure measurement according to any one of <1> to <9>, in which the electron-accepting compound is a clay substance that is at least one selected from the group consisting of acid clay, activated clay, attapulgite, zeolite, bentonite and kaolin.
<11> The material for pressure measurement according to any one of <1> to <10>, in which a total content of the inorganic filler contained in the first base material is 0.005% by mass to 5% by mass of a total amount of the first base material.

According to an embodiment of the present invention, a material for pressure measurement from which a color optical density that can be read even in a case where a fine pressure of 0.05 MPa or lower is applied, in which unevenness in a color optical density in a region to which a certain pressure is applied is suppressed in spite of the fact that the material for pressure measurement includes a first material having a color developer layer disposed on a first base material containing an inorganic filler and a second material having a developer layer disposed on a second base material is provided.

### DESCRIPTION OF THE PREFERRED EMBODIMENTS

In the present specification, numerical ranges expressed using “to” include numerical values described before and after “to” as the lower limit value and the upper limit value.

Regarding numerical ranges expressed stepwise in the present specification, an upper limit value or a lower limit value described for a certain numerical range may be substituted into the upper limit value or the lower limit value of another numerical range described stepwise. In addition, regarding numerical ranges expressed stepwise in the present specification, an upper limit value or a lower limit value described for a certain numerical range may be substituted into a value described in examples.

In the present specification, in a case where there is a plurality of substances corresponding to a certain component in a composition, unless particularly otherwise described, the amount of the component in the composition refers to the total amount of the plurality of substances present in the composition.

A material for pressure measurement according to an embodiment of the present disclosure includes a first material having a color developer layer containing a microcapsule A encapsulating an electron-donating dye precursor disposed on a first base material and a second material having a developer layer containing an electron-accepting compound disposed on a second base material, the first base material contains an inorganic filler, and a proportion of the inorganic filler having a particle diameter of 0.1 μm or more in all of the inorganic filler contained in the first base material is 5% by volume or less, and an arithmetic average roughness Ra of a surface of the developer layer satisfies 0.1 μm≤Ra≤1.1 μm.

As described above, the present inventors' studies clarified that, in a material for pressure measurement from which a color optical density that can be read even in a case where a fine pressure of 0.05 MPa or lower is applied and in which a base material containing an inorganic filler is used, unevenness in a color optical density in a region to which a certain pressure is applied is likely to be caused.

Regarding this point, in the material for pressure measurement of the embodiment of the present disclosure, a color optical density that can be read even in a case where a fine pressure of 0.05 MPa or lower is applied can be obtained, and unevenness in a color optical density in a region to which a certain pressure is applied is suppressed in spite of the fact that the material for pressure measurement includes a first material having a color developer layer disposed on a first base material containing an inorganic filler and a second material having a developer layer disposed on a second base material.

In detail, in the material for pressure measurement of the embodiment of the present disclosure, Ra of the surface of the developer layer is 0.1 μm or more, and thus a color optical density that can be read even in a case where a fine pressure of 0.05 MPa or lower is applied can be obtained. The reason therefor is considered to be because, in a case where Ra of the surface of the developer layer is 0.1 μm or more, fine protrusions and recesses are present on the surface of the developer layer, and thus pressure concentrates on protrusion portions in these fine protrusions and recesses (that is, the effective pressure increases in the protrusion portions).

Furthermore, in the material for pressure measurement of the embodiment of the present disclosure,

due to the combination of the proportion of the inorganic filler having a particle diameter of 0.1 μm or more in all of the inorganic filler contained in the first base material being 5% by volume or less and
Ra of the surface of the developer layer being 1.1 μin or less,
unevenness in the color optical density in a region to which a certain pressure is applied is suppressed. The reason therefor is considered to be because the proportion of the inorganic filler having a particle diameter of 0.1 μm or more in all of the inorganic filler contained in the first base material being 5% by volume or less reduces the protrusions and recesses on the surface of the color developer layer disposed on the first base material, Ra of the surface of the developer layer being 1.1 μm or less reduces the protrusions and recesses on the surface of the developer layer, and consequently, an effective pressure unevenness in a region to which a certain pressure (for example, 0.05 MPa) is applied is suppressed.

### [Arithmetic Average Roughness Ra]

The arithmetic average roughness Ra of the surface of the developer layer satisfies 0.1 μm≤Ra≤1.1 μm.

The arithmetic average roughness Ra in the present specification refers to the arithmetic average roughness Ra regulated by JIS B0681-6:2014.

Ra of the surface of the developer layer is 0.1 μm or more. Therefore, as described above, a color optical density that can be read even in a case where a fine pressure of 0.05 MPa or lower is applied can be obtained.

From the viewpoint of further improving a color optical density difference ΔD in a case where a fine pressure of 0.05 MPa or lower (for example, 0.03 MPa) is applied, Ra of the surface of the developer layer is preferably 0.4 μm or more, more preferably 0.5 μm or more, and still more preferably 0.7 μm or more.

Ra of the surface of the developer layer is 1.1 μm or less. Therefore, as described above, unevenness in the color optical density in a region to which a certain pressure is applied (hereinafter, also referred to as “color optical density unevenness”) can be suppressed. From the viewpoint of effectively obtaining such an effect, Ra of the surface of the developer layer is preferably 1.0 μm or less.

Ra of the surface of the developer layer is not particularly limited. As long as the first base material satisfies the above-described condition, the color optical density unevenness is suppressed.

From the viewpoint of further suppressing the color optical density unevenness, Ra of the surface of the developer layer is preferably 0.1 μm to 3.0 μm, more preferably 1.1 μm to 3.0 μm, and still more preferably 1.5 μm to 2.8 μm.

The material for pressure measurement of the embodiment of the present disclosure includes the first material including the color developer layer and the second material including the developer layer. The material for pressure measurement of the embodiment of the present disclosure is a so-called two-sheet type material for pressure measurement.

Pressure measurement using the material for pressure measurement of the embodiment of the present disclosure is carried out by superimposing the first material and the second material so that a surface of the color developer layer in the first material and a surface of the developer layer in the second material come into contact with each other.

In detail, the first material and the second material in a superimposed state are disposed in a portion in which a pressure or a pressure distribution is measured, and a pressure is applied to the first material and the second material in this state. The pressure may be any of a point pressure, a linear pressure, or a planar pressure.

The application of a pressure breaks the microcapsule A, whereby the electron-donating dye precursor and the electron-accepting compound come into contact with each other and the color development region is formed.

In the material for pressure measurement of the embodiment of the present disclosure, as described above, a color optical density that can be read even in a case where a fine pressure of 0.05 MPa or lower is applied can be obtained.

From the viewpoint of further improving the readability in a case where a fine pressure of 0.05 MPa or lower is applied, the color optical density difference ΔD before and after pressurization at a fine pressure of 0.03 MPa is preferably 0.08 MPa or more and more preferably 0.10 MPa or more.

The upper limit of the color optical density difference ΔD before and after pressurization at 0.03 MPa is not particularly limited; however, as the upper limit, for example, 0.18 can be exemplified, and 0.16 is preferred.

The color optical density difference ΔD before and after pressurization at 0.03 MPa is a value obtained by subtracting the color optical density before pressurization at 0.03 MPa from the color optical density after pressurization.

These color optical densities are values measured using a reflection densitometer (for example, RD-19I manufactured by GretagMacbeth LLC).

Hereinafter, the first material and the second material will be described.

### [First Material]

The material for pressure measurement of the embodiment of the present disclosure includes the first material having the color developer layer containing the microcapsule A encapsulating the electron-donating dye precursor disposed on the first base material.

The first material includes the first base material and the color developer layer disposed on the first base material.

### <First Base Material>

The first base material contains an inorganic filler.

The first base material containing an inorganic filler is advantageous from the viewpoint of the manufacturing aptitude of the first base material (for example, the suppression of the adhesion between films as the first base material during the coiling of the films in a roll shape). In addition, it is considered that the first base material containing an inorganic filler is also advantageous from the viewpoint of improving the color optical density difference ΔD before and after pressurization at 0.03 MPa.

The shape of the first base material may be any of a sheet shape, a film shape, or a plate shape.

The proportion of an inorganic filler having a particle diameter of 0.1 μm or more in all of the inorganic filler contained in the first base material is 5% by volume or less. In such a case, as described above, the color optical density unevenness is suppressed.

From the viewpoint of further suppressing the color optical density unevenness, the proportion of the inorganic filler having a particle diameter of 0.1 μm or more in all of the inorganic filler contained in the first base material is preferably 3% by volume or less, more preferably 2% by volume or less, still more preferably 1% by volume or less, and ideally 0% by volume.

As the inorganic filler, inorganic particles such as calcium carbonate particles, calcium phosphate particles, amorphous silica particles, spherical silica particles, crystalline glass filler particles, kaolin particles, talc particles, titanium dioxide particles, alumina particles, silica-alumina composite oxide particles, barium sulfate particles, calcium fluoride particles, lithium fluoride particles, zeolite particles, molybdenum sulfide particles, and mica particles; heat-resistant fine polymer particles such as crosslinked polystyrene particles, crosslinked acrylic resin particles, crosslinked methyl methacrylate particles, benzoguanamine-formaldehyde condensate particles, melamine-formaldehyde condensate particles, and polytetrafluoroethylene particles; and the like are exemplified.

In a case where the first base material contains the inorganic filler, the first base material preferably further contains a resin (for example, polyester, polyolefin, polystyrene, or the like), more preferably contains polyester, and particularly preferably contains polyester polyethylene terephthalate.

In a case where the first base material contains the inorganic filler and a resin, the proportion of the inorganic filler having a particle diameter of 0.1 μm or more in all of the inorganic filler contained in the first base material is obtained as described below.

At least a part of the resin is decomposed and removed from the first base material by firing the first base material, thereby leaving the inorganic filler. The left inorganic filler is dispersed in ethanol. Regarding the inorganic filler included in the obtained dispersion liquid, the volume-based particle size distribution is obtained by a wet-type method using a laser diffraction particle size distribution measurement instrument (for example, Mastersizer 2000 manufactured by Malvern Panalytical Ltd., a laser diffraction/scattering-type particle size distribution measurement instrument LA-920 manufactured by Horiba, Ltd., or the like). From the obtained particle size distribution, the proportion (% by volume) of the inorganic filler having a particle diameter of 0.1 μm or more in all of the inorganic filler is obtained.

The total content of the inorganic filler with respect to the total amount of the first base material is not particularly limited, and, as the total content, for example, 0.005% by mass to 5% by mass are exemplified, and 0.1% by mass to 5% by mass is preferred, 0.5% by mass to 5% by mass is more preferred, 1% by mass to 4% by mass is still more preferred, and 1% by mass to 3% by mass is particularly preferred.

In a case where the first base material contains the inorganic filler and a resin, the first base material may also contain components other than the inorganic filler and the resin.

In a case where the first base material contains the inorganic filler and a resin, the content of the resin is preferably 50% by mass or more, more preferably 60% by mass or more, and still more preferably 80% by mass or more of the total mass of the first base material.

The upper limit of the content of the resin in this case is appropriately set depending on the content of the inorganic filler (and the content of the other components used as necessary).

### <Color Developer Layer>

In the first material, the color developer layer is disposed on the first base material.

The color developer layer may be disposed on the first base material through an additional layer (an undercoat layer, an easily adhesive layer, or the like) or may be disposed adjacent to the first base material. Here, the color developer layer being disposed adjacent to the first base material means that the additional layer (an undercoat layer, an easily adhesive layer, or the like) is not present between the first base material and the color developer layer.

In the first material, the color developer layer is preferably adjacent to the first base material (that is, disposed adjacent to the first base material on the first base material).

In an aspect in which the color developer layer is adjacent to the first base material, the shape of the surface of the first base material is likely to be reflected in the shape of the surface of the color developer layer, and thus the effect of the proportion of the inorganic filler having a particle diameter of 0.1 μm or more in all of the inorganic filler contained in the first base material being 5% by volume or less (suppression of color optical density unevenness) is more effectively exhibited.

The color developer layer in the first material contains the microcapsule A encapsulating an electron-donating dye precursor.

The color developer layer may contain only one kind of microcapsule A or may contain two or more kinds of microcapsules A. For example, the color developer layer may contain two or more kinds of microcapsules A having different volume-based median sizes.

In the color developer layer, the coefficient of variation of the number-based particle size distribution of particles having a particle diameter of 2 μm or more contained in the color developer layer (hereinafter, also referred to as “the CV value of the particle size distribution of the color developer layer” or simply as “the CV value of the particle size distribution”) is preferably 50% to 100%.

In a case where the CV value of the particle size distribution of the color developer layer is 50% or more, the gradation property of color development is excellent.

Here, “the gradation property of color development” refers to a property of the color optical density increasing with an increase in a pressure being applied thereto. A particularly preferred gradation property of color development is a property of the color optical density linearly increasing with an increase in pressure in a pressure range of 0.06 MPa or less (that is, the pressure and the color optical density are proportional to each other).

From the viewpoint of further improving the gradation property of color development, the CV value of the particle size distribution of the color developer layer is more preferably 55% or more and still more preferably 60% or more.

Even in a case where the CV value of the particle size distribution of the color developer layer is 100% or less, the gradation property of color development improves.

From the viewpoint of further improving the gradation property of color development, the CV value of the particle size distribution of the color developer layer is more preferably 95% or less and still more preferably 80% or less.

In the present specification, the CV value of the particle size distribution of the color developer layer (that is, the coefficient of variation of the number-based particle size distribution of particles having a particle diameter of 2 μm or more contained in the color developer layer) refers to a value measured as described below.

The surface of the color developer layer in the first material is captured using an optical microscope at 100 times, and the particle diameters of 400 particles having a particle diameter of 2 μm or more included in a range of 0.15 cm² are measured respectively. Here, the particle diameter is regarded as the equivalent circle diameter. In a case where the number of particles having a particle diameter of 2 μm or more in a range of 0.15 cm² does not reach 400, particles having a particle diameter of 2 μm or more present near the range of 0.15 cm² are also regarded as measurement subjects.

Next, the number-based particle size distribution for which the measurement values of 400 particles having a particle diameter of 2 μm or more are used as the population is obtained, and the standard deviation and the number-average particle diameter are respectively calculated on the basis of the obtained particle size distribution.

The CV value of the particle size distribution of the color developer layer is obtained from the following equation on the basis of the obtained standard deviation and number-average particle diameter.

CV value of particle size distribution of color developer layer (%)=(standard deviation/number-average particle diameter)×100

As the particle having a particle diameter of 2 μm or more, specifically, the microcapsule A is exemplified.

In a case where a microcapsule B described below is contained in the color developer layer, as the particle having a particle diameter of 2 μm or more, specifically, the microcapsule B is also exemplified.

The CV value of the particle size distribution of the color developer layer can be adjusted by, for example, jointly using two or more kinds of microcapsules having different volume-based median sizes and adjusting the mixing ratio of the two or more kinds of microcapsules and/or the volume-based median sizes of the respective microcapsules.

As the two or more kinds of microcapsules having different volume-based median sizes, for example, two or more kinds of microcapsules A having different volume-based median sizes, the microcapsule A and the microcapsule B having different volume-based median sizes, and the like are exemplified.

### (Microcapsule A)

The microcapsule A encapsulates, as a color developer, an electron-donating dye precursor.

### Electron-Donating Dye Precursor

As the electron-donating dye precursor, any substance having a property of developing color by donating an electron or accepting a proton (hydrogen ion: H⁺) of an acid can be used without any particular limitation, and the electron-donating dye precursor is preferably colorless.

Particularly, as the electron-donating dye precursor, a colorless compound having a partial skeleton such as a lactone, a lactam, a sultone, a spiropyran, an ester, an amide, or the like which ring-opens or cleaves in the case of coming into contact with an electron-accepting compound described below.

As the electron-donating dye precursor, specifically, a triphenylmethanephthalide-based compound, a fluoran-based compound, a phenothiazine-based compound, an indolylphthalide-based compound, a leucoauramine-based compound, a rhodamine lactam compound, a triphenylmethane-based compound, a diphenylmethane-based compound, a triazene-based compound, a spiropyran-based compound, a fluorine-based compound, and the like are exemplified.

Regarding the detail of the above-described compounds, the description of JP1993-257272A (JP-H5-257272A) can be referred to.

One kind of electron-donating dye precursor may be used singly or two or more kinds of electro-donating dye precursors may also be used in a mixture fo

As the electron-donating dye precursor, from the viewpoint of enhancing color developability in a fine pressure range of 0.05 MPa or less and developing a density change (density gradient) in a broad pressure range, an electron-donating dye precursor having a high molar light absorption coefficient (ϵ) is preferred. The molar light absorption coefficient (ϵ) of the electron-donating dye precursor is preferably 10,000 mol⁻¹·cm⁻¹·L or more, more preferably 15,000 mol⁻¹·cm⁻¹·L or more, and still more preferably 25,000 mol⁻¹·cm⁻·L or more.

As preferred examples of the electron-donating dye precursor having c in the above-described range, 3-(4-diethylamino-2-ethoxyphenyl)-3-(1-ethyl-2-methylindol-3-yl)-4-azaphthalide (ϵ=61,000), 3-(4-diethylamino-2-ethoxyphenyl)-3-(1-n-octyl-2-methylindol-3-yl) phthalide (ϵ=40,000), 3-[2,2-bis(1-ethyl-2-methylindol-3 -yl) vinyl]-3-(4-diethylaminophenyl)-phthalide (ϵ=40,000), 9-[ethyl(3-methylbutyl)amino] spiro [12H-benzo[a]xanthene-12,1′(3′H)isobenzofuran]-3′-one (ϵ=34,000), 2-anilino-6-dibutylamino-3-methylfluorane (ϵ=22,000), 6-diethylamino-3-methyl-2-(2,6-xylidino)-fluorane (ϵ=19,000), 2-(2-chloroanilino)-6-dibutylaminofluoran (ϵ=21,000), 3,3-bis(4-dimethylaminophenyl)-6-dimethylaminophthalide (ϵ=16,000), 2-anilino-6-diethylamino-3-methylfluoran (ϵ=16,000), and the like are exemplified.

In a case where one kind of electron-donating dye precursor having a molar light absorption coefficient c in the above-described range is singly used or two or more kinds of electron-donating dye precursors having a molar light absorption coefficient c in the above-described range are used in a mixture form, the proportion of the electron-donating dye precursor having a molar light absorption coefficient c of 10,000 mol⁻¹·cm⁻¹·L or more in the total amount of the electron-donating dye precursor is preferably in a range of 10% by mass to 100% by mass, more preferably in a range of 20% by mass to 100% by mass, and still more preferably in a range of 30% by mass to 100% by mass from the viewpoint of enhancing color developability in a fine pressure range of 0.05 MPa or less and developing a density change (density gradient) in a broad pressure range.

In the case of using two or more kinds of electron-donating dye precursors, it is preferable to jointly use two or more kinds of electron-donating dye precursors each having ϵ of 10,000 mol⁻¹·cm⁻¹·L or more.

The molar light absorption coefficient (ϵ) can be computed from the light absorbance at the time of dissolving an electron-donating colorless dye in a 95% acetic acid aqueous solution. Specifically, in a case where, in a 95% acetic acid aqueous solution of an electron-donating colorless dye having a concentration adjusted so that the light absorbance reaches 1.0 or less, the length of a cell for measurement is represented by A cm, the concentration of the electron-donating colorless dye is represented by B mol/L, and the light absorbance is represented by C, the molar light absorption coefficient can be computed from the following equation.

Molar light absorption coefficient (ϵ)=C/(A×B)

The content (for example, amount applied) of the electron-donating dye precursor in the color developer layer is preferably 0.1 g/m² to 5 g/m², more preferably 0.1 g/m² to 4 g/m², and still more preferably 0.2 g/m² to 3 g/m² in terms of the mass after drying from the viewpoint of enhancing color developability in a fine pressure range of 0.05 MPa or less.

### Solvent

The microcapsule A preferably encapsulates at least one solvent.

As the solvent, it is possible to use solvents that are well known in the applications of pressure sensitive copying paper or thermosensitive recording paper.

As the solvent, specifically, for example, aromatic hydrocarbons such as alkylnaphthalene-based compounds such as diisopropyl naphthalene, diarylalkane-based compounds such as 1-phenyl-1-xylylethane, alkylbiphenyl-based compounds such as isopropylbiphenyl, triarylmethane-based compounds, alkylbenzene-based compounds, benzylnaphthalene-based compounds, diarylalkylene-based compounds, and arylindane-based compounds; aliphatic hydrocarbons such as dibutyl phthalate and isoparaffins; natural animal and vegetable oils such as soybean oil, corn oil, cottonseed oil, rapeseed oil, olive oil, coconut oil, castor oil, and fish oil; natural product high-boiling fractions such as paraffinum liquidum; and the like are exemplified.

One kind of solvent may be used singly or two or more kinds of solvents may be used in a mixture form.

From the viewpoint of color developability, the mass ratio (solvent:precursor) between the solvent and the electron-donating dye precursor that are encapsulated in the microcapsule A is preferably in a range of 98:2 to 30:70, more preferably in a range of 97:3 to 40:60, and still more preferably in a range of 95:5 to 50:50.

### Auxiliary Solvent

The microcapsule A may also encapsulate an auxiliary solvent as necessary.

As the auxiliary solvent, solvents having a boiling point of 130° C. or lower are exemplified.

As the auxiliary solvent, more specifically, for example, ketone-based compounds such as methyl ethyl ketone, ester-based compounds such as ethyl acetate, alcohol-based compounds such as isopropyl alcohol, and the like are exemplified.

### Other Components

The microcapsule A may also contain components other than the above-described components as necessary.

As the other components, additives such as an ultraviolet absorber, a light stabilizer, an antioxidant, wax, and an odor suppressor can be exemplified.

### Volume-Based Median Size (D50A) of Microcapsule A

The volume-based median diameter (hereinafter, also referred to as “D50A”) of the microcapsule A is not particularly limited, but is preferably more than 10 μm and less than 40 μm.

In a case where D50A is less than 40 μm, the color developability does not become too high, and thus color development by rubbing can be further suppressed.

In a case where D50A is more than 10 μm, it is possible to further suppress unevenness on the surface of the color developer layer (for example, application unevenness in an aspect in which the color developer layer is formed by application).

D50A is preferably 20 μm to 35 μm and more preferably 25 μm to 35 μm.

### Number-Average Wall Thickness of Microcapsule A

The number-average wall thickness of the microcapsule A depends on a variety of conditions such as the material of the capsule wall and D50A and is preferably 10 nm to 150 nm, more preferably 20 nm to 100 nm, and still more preferably 20 nm to 90 nm from the viewpoint of color developability in a fine pressure range of 0.05 mPa or lower.

In the present specification, a wall thickness of the microcapsule refers to the thickness (μm) of a capsule wall (for example, a resin film that forms the microcapsule) of the microcapsule. The concept of the microcapsule mentioned herein include both the microcapsule A and the microcapsule B.

The number-average wall thickness of the microcapsule refers to a number average value obtained by obtaining the thicknesses (μm) of the respective capsule walls of five microcapsules using a scanning electron microscope (SEM) and number-averaging (that is, simply averaging) the obtained measurement values (five measurement values) of the thicknesses of the capsule walls.

Specifically, first, a microcapsule-containing liquid is applied onto a random base material (for example the first base material) and dried, thereby forming an applied film. A cross-sectional slice of the obtained applied film is produced, and the cross section thereof is observed using SEM. From the obtained SEM image, five random microcapsules are selected. The cross sections of the selected five microcapsules are observed, and the thicknesses of the capsule walls of the five microcapsules are obtained respectively. The measurement values (five measurement values) of the thicknesses of the capsule walls are number-averaged, and the obtained number-average value is regarded as the number-average wall thickness of the microcapsule.

The ratio of the number-average wall thickness of the microcapsule A to D50A of the microcapsule A (that is, the number-average wall thickness/D50A ratio) is preferably 1.0×10⁻³ to 4.0×10⁻³ and more preferably 1.3×10⁻³ to 2.5×10⁻³ from the viewpoint of color developability in a fine pressure range of 0.05 MPa or less.

### Wall Material of Microcapsule A

As a wall material of the microcapsule A (that is, a material of the capsule wall), a resin is preferred.

As the wall material of the microcapsule A, for example, resins known as a wall material of electron-donating dye precursor-containing microcapsules in pressure sensitive recording materials or thermosensitive recording materials (for example, a urethane-urea resin, a melamine formaldehyde resin, gelatin, and the like) are exemplified.

As the wall material of the microcapsule A, from the viewpoint of obtaining favorable color development at a low pressure (preferably lower than 0.1 MPa), a urethane-urea resin or a melamine formaldehyde resin is preferred.

As the wall material of the microcapsule A, from the viewpoint of maintaining the ratio of the color optical density in the case of using the first material after storage to the color optical density in the case of using the first material before storage on a higher level, a melamine formaldehyde resin is preferred.

From the viewpoint of obtaining favorable color development at a low pressure (preferably lower than 0.1 MPa), the content of the microcapsule A in the color developer layer is preferably 50% by mass or more and more preferably 60% by mass or more of the total solid content amount of the color developer layer.

The upper limit of the content of the microcapsule A with respect to the total solid content amount of the color developer layer is not particularly limited, and, as the upper limit, for example, 80% by mass can be exemplified.

### (Microcapsule B)

From the viewpoint of suppressing color development by rubbing, at least one of the color developer layer in the first material or the developer layer in the second material preferably contains a microcapsule B not encapsulating the electron-donating dye precursor.

Here, “color development by rubbing” refers to color development caused by the rubbing of the color developer layer in the first material and the developer layer in the second material at the time of not measuring pressures. In summary, color development by rubbing is undesirable color development from the viewpoint of pressure measurement (that is, unintended color development).

In a case where at least one of the color developer layer in the first material or the developer layer in the second material contains the microcapsule B not encapsulating the electron-donating dye precursor, the breakage of the microcapsule B at the time of the rubbing between the color developer layer in the first material and the developer layer in the second material suppresses the breakage of the microcapsule A. Therefore, color development by rubbing is suppressed. That is, the microcapsule B has a function of suppressing the breakage of the microcapsule A by being broken (that is, a function as a dummy capsule).

In a case where at least one of the color developer layer in the first material or the developer layer in the second material contains the microcapsule B, only one kind of microcapsule B may be contained or two or more kinds of microcapsules (for example, two or more kinds of microcapsules having different volume-based median sizes) may be contained.

The microcapsule B can be contained at least one of the color developer layer in the first material or the developer layer in the second material; however, from the viewpoint of more effectively exhibiting an effect for suppressing color development by rubbing, the microcapsule is preferably contained in the color developer layer in the first material.

### Components Encapsulated in Microcapsule B

The microcapsule B preferably encapsulates a solvent.

A preferred solvent that can be encapsulated in the microcapsule B is the same as the preferred solvent that can be ensulated in the microcapsule A.

Additionally, as components that can be ensulated in the microcapsule B, the components that can be encapsulated in the microcapsule A except for the electron-donating dye precursor are exemplified.

### Volume-Based Median Size (D50B) of Microcapsule B

The volume-based median diameter (hereinafter, also referred to as “D50B”) of the microcapsule B is preferably larger than D50A of the microcapsule A from the viewpoint of further suppressing color development by rubbing. In such a case, an effect of the microcapsule B for suppressing color development by rubbing is more effectively exhibited.

D50B of the microcapsule B is preferably more than 40 μm and less than 150 μm.

In a case where D50B of the microcapsule B is more than 40 μm, the effect for suppressing color development by rubbing is more effectively exhibited.

In a case where D50B of the microcapsule B is less than 150 μm, it is possible to further suppress unevenness on the color developer layer and/or the developer layer in which the microcapsule B is contained (for example, application unevenness in the aspect in which the color developer layer is formed by application). In addition, in a case where the microcapsule B is contained in the color developer layer and D50B is less than 150 μm, the CV value of the particle size distribution in the color developer layer does not become too large, and thus the gradation property of color development further improves.

A preferred aspect of the case where at least one of the color developer layer in the first material or the developer layer in the second material contains the microcapsule B is an aspect in which D50A of the microcapsule A is more than 10 μm and less than 40 μm and D50B of the microcapsule B is more than 40 μm and less than 50 μm. A more preferred range of each of D50A and D50B in this aspect is as described above.

### Number-Average Wall Thickness of Microcapsule B

The number-average wall thickness of the microcapsule B depends on a variety of conditions such as the material of the capsule wall and D50OB and is preferably 50 nm to 1,000 nm, more preferably 70 nm to 500 nm, still more preferably 100 nm to 300 nm, and still more preferably 100 nm to 200 nm from the viewpoint of more effectively exhibiting the function of the microcapsule B.

The ratio of the number-average wall thickness of the microcapsule B to D50B of the microcapsule B (that is, the number-average wall thickness/D50B ratio) is preferably 1.0×10⁻³ to 4.0×10⁻³ and more preferably 1.3×10⁻³ to 2.5×10⁻³ from the viewpoint of more effectively exhibiting the function of the microcapsule B.

### Wall Material of Microcapsule B

A preferred aspect of a wall material of the microcapsule B is the same as the preferred aspect of the wall material of the microcapsule A.

In a case where the color developer layer contains the microcapsule B, from the viewpoint of more effectively exhibiting the function of the microcapsule B, the content of the microcapsule B with respect to the content of the microcapsule A in the color developer layer is preferably 1% by mass to 50% by mass and more preferably 5% by mass to 50% by mass, and still more preferably 10% by mass to 30% by mass.

### (Other Components)

The color developer layer may contain components other than the microcapsule A and the microcapsule B.

As the other components, a water-soluble polymeric binder (for example, fine powder of starch or a starch derivative, a buffer such as cellulose fiber powder, polyvinyl alcohol, or the like), a hydrophobic polymeric binder (for example, a vinyl acetate-based binder, an acrylic binder, a styrene butadiene copolymer latex, or the like), a surfactant, inorganic particles (for example, silica particles), a fluorescent brightener, an antifoaming agent, a penetrating agent, an ultraviolet absorber, a preservative, and the like are exemplified.

As the surfactant that is used in the color developer layer, for example, an alkylbenzene sulfonate that is an anionic surfactant (for example, NEOGEN T manufactured by DKS Co., Ltd.), polyoxyalkylene lauryl ether that is a nonionic surfactant (for example, NOIGEN LP70 manufactured by DKS Co., Ltd.), and the like are exemplified.

As the silica particles that are used in the color developer layer, for example, gas phase process silica, colloidal silica, and the like are exemplified.

Regarding the silica particles, as examples of a commercially available product in the market, SNOWTEX series manufactured by Nissan Chemical Corporation (for example, SNOWTEX (registered trademark) 30) and the like are exemplified.

### (Coating Fluid for Forming Color Developer Layer)

The color developer layer can be formed by, for example, imparting (for example, applying) a coating fluid for forming the color developer layer containing the above-described components of the color developer layer and a liquid component (for example, water) to the first base material and drying the coating fluid.

The coating fluid for forming the color developer layer can be prepared by, for example, preparing a water dispersion liquid of the microcapsule A and, as necessary, mixing the water dispersion liquid of the microcapsule A and other components.

In the case of forming the color developer layer containing two or more kinds of microcapsules A having different D50A's or the like, it is preferable to prepare water dispersion liquids for the two or more kinds of microcapsules A each and prepare coating fluids for forming the color developer layer using the obtained water dispersion liquids of the two or more kinds of microcapsules A.

The coating fluid for forming the color developer layer which is intended to form the color developer layer containing the microcapsule B is preferably prepared by preparing a water dispersion liquid of the microcapsule A and a water dispersion of the microcapsule B respectively and using the obtained water dispersion liquid of the microcapsule A, the obtained water dispersion of the microcapsule B, and other components.

In the case of forming the color developer layer by applying the coating fluid for forming the color developer layer onto the first base material, the coating fluid can be applied using a well-known application method.

As the application method, for example, application methods using an air knife coater, a rod coater, a bar coater, a curtain coater, a gravure coater, an extrusion coater, a die coater, a slide bead coater, a blade coater, or the like are exemplified.

The mass of the color developer layer that is formed on the first base material (the mass after drying in the case of forming the color developer layer by application and drying) is preferably 1 g/m² to 10 g/m², more preferably 1 g/m² to 5 g/m², and particularly preferably 2 g/m² to 4 g/m².

### [Second Material]

The material for pressure measurement of the embodiment of the present disclosure includes the second material having the developer layer containing the electron-accepting compound disposed on the second base material.

The second material includes the second base material and the developer layer disposed on the second base material.

Ra of the surface of the developer layer is, as described above, 0.1 μm to 1.1 μm (that is, 0.1 μm≤Ra≤1.1 μm). Therefore, as described above, a color optical density that can be read even in a case where a fine pressure of 0.05 MPa or lower is applied can be obtained, and color optical density unevenness is suppressed.

A more preferred range of Ra of the surface of the developer layer is also as described above.

### <Second Base Material>

The second base material is not particularly limited, and it is possible to use base materials that are well known as base materials for thermosensitive recording materials or pressure sensitive recording materials.

As long as Ra of the surface of the developer layer disposed on the second base material satisfies the above-described condition, the effect of the material for pressure measurement of the embodiment of the present disclosure is exhibited regardless of the base material that is used as the second base material.

The shape of the second base material may be any of a sheet shape, a film shape, or a plate shape.

As specific examples of the second base material, paper, a plastic film, synthetic paper, and the like are exemplified.

As specific examples of the paper, wood-free paper, medium-grade paper, groundwood-grade paper, neutral paper, acid paper, recycled paper, coated paper, machine coated paper, art paper, cast coated paper, finely coated paper, tracing paper, and the like can be exemplified.

As specific examples of the plastic film, a polyester film such as a polyethylene terephthalate film, a cellulose derivative film such as cellulose triacetate, a polyolefin film such as polypropylene or polyethylene, a polystyrene film, and the like can be exemplified.

As specific examples of the synthetic paper, paper having a number of microvoids formed by biaxially stretching polypropylene, polyethylene terephthalate, or the like (YUPO and the like), paper produced using a synthetic fiber such as polyethylene, polypropylene, polyethylene terephthalate, or polyamide, paper obtained by laminating the above-described paper on a part, a single surface, or both surfaces, and the like are exemplified.

Among these, from the viewpoint of further increasing the color optical density generated by pressurization, the plastic film and the synthetic paper are preferred, and the plastic film is more preferred.

In addition, as the second base material, the same base material as the first base material may be used.

### <Developer Layer>

In the second material, the developer layer is disposed on the second base material.

The developer layer may be disposed on the second base material through an additional layer (an undercoat layer, an easily adhesive layer, or the like) or may be disposed adjacent to the second base material.

### (Electron-Accepting Compound)

The developer layer includes an electron-accepting compound as a developer. As the developer included in the developer layer, only one kind of electron-accepting compound may be used or two or more kinds of electron-accepting compounds may be used.

As the electron-accepting compound, an inorganic compound and an organic compound can be exemplified.

As specific examples of the inorganic compound, clay substances such as acid clay, activated clay, attapulgite, zeolite, bentonite, and kaolin are exemplified. As the activated clay, sulfate-treated activated clay obtained by treating acid clay or bentonite with sulfuric acid is preferred.

As specific examples of the organic compound, metal salts of aromatic carboxylic acids, phenol formaldehyde resins, metal salts of carboxylated terpene phenol resins, and the like are exemplified.

As preferred specific examples of the metal salts of aromatic carboxylic acids, zinc salts, nickel salts, aluminum salts, calcium salts, and the like of salicylic acid resins that are reaction products between 3,5-di-t-butylsalicylic acid, 3,5-di-t-octylsalicylic acid, 3,5-di-t-nonylsalicylic acid, 3,5-di-t-dodecylsalicylic acid, 3-methyl-5-t-dodecylsalicylic acid, 3-t-dodecylsalicylic acid, 5-t-dodecylsalicylic acid, 5-cyclohexylsalicylic acid, 3,5-bis(α,α-dimethylbenzyl) salicylic acid, 3-methyl-5-(α-methylbenzyl)) salicylic acid, 3-(α,α-dimethylbenzyl)-5-methylsalicylic acid, 3-(α,α-dimethylbenzyl)-6-methylsalicylic acid, 3 -(α-methylbenzyl)-5-(α,α)-dimethylbenzyl) salicylic acid, 3-(α,α-dimethylbenzyl)-6-ethylsalicylic acid, 3-phenyl-5-(α,α-dimethylbenzyl) salicylic acid, carboxy-modified terpene phenolic resin, or 3,5-bis(α-methylbenzyl) salicylic acid and benzyl chloride can be exemplified.

As the electron-accepting compound, a clay substance, a metal salt of an aromatic carboxylic acid, or a metal salt of a carboxylated terpene phenol resin is preferred, and a clay substance or a metal salt of an aromatic carboxylic acid is more preferred.

From the viewpoint of increasing color development rate and the viewpoint of further improving the color optical density difference ΔD in a case where a fine pressure of 0.05 MPa or lower (for example, 0.03 MPa) is applied, as the electron-accepting compound, a clay substance that is at least one selected from the group consisting of acid clay, activated clay, attapulgite, zeolite, bentonite, or kaolin is preferred, and a clay substance that is at least one selected from the group consisting of acid clay, activated clay, or kaolin is more preferred.

### (Other Components)

The developer layer may contain components other than the electron-accepting compound.

As the other components, a binder resin, a pigment, a fluorescent brightener, an antifoaming agent, a penetrating agent, a preservative, and the like are exemplified.

As the other components, the microcapsule B is also exemplified.

As the binder resin, for example, styrene-butadiene copolymers, vinyl acetate-based polymers, polyvinyl alcohol, maleic anhydride-styrene copolymers, synthetic or natural polymeric substances such as starch, casein, arabic gum, gelatin, carboxymethylcellulose, and methylcellulose are exemplified.

As the pigment, for example, heavy calcium carbonate, light calcium carbonate, talc, rutile-type titanium dioxide, anatase-type titanium dioxide, and the like are exemplified.

The mass of the developer layer that is formed on the second base material is preferably 1 g/m² to 20 g/m², more preferably 2 g/m² to 18 g/m², and particularly preferably 3 g/m² to 15 g/m².

The developer layer can be formed by, for example, imparting (for example, applying) a coating fluid for foiming the developer layer containing the components (at least the electron-accepting compound) of the developer layer and a liquid component (for example, water) to the second base material and drying the coating fluid.

The coating fluid for forming the developer layer is preferably, for example, a water dispersion liquid of the electron-accepting compound. Ra of the surface of the developer layer can be adjusted by adjusting the dispersion condition of the electron-accepting compound during the preparation of a water dispersion liquid of the electron-accepting compound.

As an application method in the case of forming the developer layer by applying the coating fluid for forming the developer layer onto the second base material, the same method as the application method of the coating fluid for forming the color developer layer is exemplified.

### EXAMPLES

Hereinafter, the present invention will be specifically described using examples, but the present invention is not limited to the following examples within the scope of the gist of the present invention. In the following description, unless particularly otherwise described, “%” and “parts” are mass-based.

In the following description, the densities of color development regions were measured using a reflection densitometer RD-19I (manufactured by GretagMacbeth LLC).

### Example 1

### <Preparation of Microcapsule A1-Containing Liquid>

The following compound (A) (20 parts) that is an electron-donating dye precursor was dissolved in linear alkyl benzene (JXTG Nippon Oil & Energy Corporation, GRADE ALKENE L) (57 parts), thereby obtaining a solution A.

The obtained solution A was stirred, and synthetic isoparaffin (Idemitsu Kosan Co., Ltd., IP SOLVENT 1620) (15 parts) and N,N,N′,N′-tetrakis(2-hydroxypropyl)ethylene diamine (ADEKA Corporation, ADEKA POLYETHER EDP-300) dissolved in ethyl acetate (1.2 parts) (0.2 parts) were added thereto, thereby obtaining a solution B.

The obtained solution B was stirred, and a trimethylolpropane adduct of torylene diisocyanate (DIC Corporation, BURNOCK D-750) dissolved in ethyl acetate (3 parts) (1.4 parts) was added thereto, thereby obtaining a solution C.

Next, the solution C was added to a solution obtained by dissolving polyvinyl alcohol (PVA-205, Kuraray Co., Ltd.) (10 parts) in water (140 parts), emulsified, and dispersed. Water (340 parts) was added to the obtained emulsified liquid, heated up to 70° C. under stirring, stirred for one hour, and then cooled. Water was further added to the cooled liquid, thereby adjusting the concentration of the solid content.

A microcapsule A1-containing liquid containing a microcapsule A1 as the microcapsule A encapsulating an electron-donating dye precursor (concentration of solid content: 19.6%) was obtained in the above-described manner.

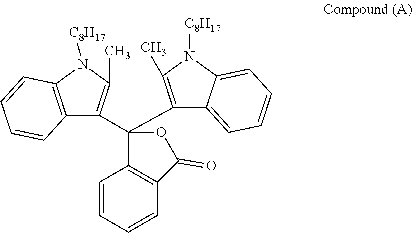

For the microcapsule A1 that was contained in the microcapsule A1-containing liquid, the volume-based median size (hereinafter, also referred to as “D50A”) and the number-average wall thickness (hereinafter, also referred to as “wall thickness”) were values shown in Table 1.

In addition, a material of a capsule wall (hereinafter, also referred to as “wall material”) of the microcapsule A1 was, as shown in Table 1, a urethane-urea resin (hereinafter, also referred as “PUR”).

The D50A and wall thickness of the microcapsule A1 were computed as described below.

First, the microcapsule A1-containing liquid was applied and dried on a 75 μm-thick polyethylene terephthalate (PET) sheet, thereby obtaining an applied film.

D50A of the microcapsule A1 was computed on the basis of a result obtained by capturing a surface of the applied film using an optical microscope at a magnification of 150 times and measuring the equivalent circle diameters of all of the microcapsule A1 present in a 2 cm×2 cm range.

The wall thickness (that is, the number-average wall thickness) of the microcapsule A1 was computed by forming a cross section of the applied film, selecting five microcapsule A1 from the formed cross section, obtaining the thicknesses (μm) of individual capsule walls using a scanning electron microscope (SEM), and simply averaging the obtained values.

### <Preparation of Coating Fluid for Forming Color Developer Layer>

The microcapsule A1-containing liquid (18 parts), water (63 parts), colloidal silica (Nissan Chemical Corporation, SNOWTEX 30, content of solid content: 30%) (1.8 parts), a 10% aqueous solution of carboxymethylcellulose sodium (DKS Co., Ltd., CELLOGEN 5A) (1.8 parts), a 1% aqueous solution of carboxymethylcellulose sodium (DKS Co., Ltd., CELLOGEN EP) (30 parts), a 15% aqueous solution of sodium alkylbenzene sulfonate (DKS Co., Ltd., NEOGEN T) (0.3 parts), and a 1% aqueous solution of NOIGEN LP70 (DKS Co., Ltd.) (0.8 parts) were mixed together, thereby obtaining a coating fluid for forming a color developer layer.

### <Production of First Base Material>

Polyester (polyethylene terephthalate in detail) and an inorganic filler (amorphous silica particles, volume-average particle diameter: 0.02 μm) were melted and kneaded, thereby producing pellets containing the inorganic filler. The amount of the inorganic filler used was set to an amount at which the total content of inorganic filler with respect to all of the finally obtained first base material reached 2% by mass.

The obtained pellets were melted, extruded, and then biaxially stretched, thereby obtaining a 75 μm-thick first base material.

In the obtained first base material, the proportion of the inorganic filler having a particle diameter of 0.1 μpm or more in all of the inorganic filler contained was 0% by volume.

### <Production of First Material>

The coating fluid forming a color developer layer was stirred for two hours, then, applied onto a first base material so that the mass after drying reached 2.8 g/m², and dried, thereby forming a color developer layer.

A first material having the color developer layer containing the microcapsule A1 disposed on the first base material was obtained in the above-described manner.

### <Preparation of Coating Fluid for Forming Developer Layer>

3,5-Di-α-zinc methylbenzylsalicylate (hereinafter, also simply referred to as “zinc salicylate”) that is an electron-accepting compound (10 parts), calcium carbonate (100 parts), sodium hexametaphosphate (1 part), and water (200 parts) were dispersed using a sand grinder so that the average particle diameter of all particles reached 2 μm, thereby preparing a dispersion liquid. Next, a polyvinyl alcohol (PVA-203, Kuraray Co., Ltd.) 10% aqueous solution (100 parts), styrene-butadiene latex (10 parts in terms of the solid content), and water (450 parts) were added to the prepared dispersion liquid, thereby obtaining a coating fluid for forming a developer layer containing the electron-accepting compound.

### <Production of Second Material>

The coating fluid for forming a developer layer was applied onto a 75 μm-thick polyethylene terephthalate (PET) sheet (second base material) so that the dried film thickness reached 12 μm and dried, thereby forming a developer layer.

A second material having the developer layer containing the electron-accepting compound (zinc salicylate) disposed on the second base material was obtained in the above-described manner.

A two-sheet type material for pressure measurement including the first material and the second material was obtained in the above-described manner.

### <Measurement and Evaluation>

The following measurement and evaluation were carried out using the obtained material for pressure measurement.

The results are shown in Table 1.

### (CV Value of Particle Size Distribution)

The coefficient of variation of the number-based particle size distribution of particles having a particle diameter of 2 μm or more contained in the color developer layer in the first material (in the present embodiment, referred to as “the CV value of the particle size distribution”) was measured using the above-described method.

### (Arithmetic Average Roughness Ra of Surface of Developer Layer)

The arithmetic average roughness Ra of the surface of the developer layer in the second material was measured using a scanning-type white interferometer using optical interferometry (in detail, NewView5020: Micro mode manufactured by Zygo Corporation).

### (Color Optical Density Difference ΔD Before and After Pressurization in Condition of 0.03 MPa)

The first material and the second material were respectively cut to a 5 cm×5 cm size.

The cut first material and the cut second material were superimposed so that a surface of the color developer layer in the first material and a surface of the developer layer in the second material came into contact with each other.

The superimposed first material and second material were placed on a desk in a state of being sandwiched between two glass plates having a flat surface, and then a weight was placed on these two glass plates, thereby pressurizing the first material and the second material sandwiched between the two glass plates at a pressure of 0.03 MPa for 120 seconds.

After pressurization, the first material and the second material were peeled off from each other.

Next, the density after 20 minutes from the end of the pressurization (hereinafter, regarded as “color optical density DA”) in a color development region formed in the developer layer in the second material was measured.

Separately from the above-described density, the density of the developer layer in an unused second material (hereinafter, regarded as “initial density DB”) was measured.

The initial density DB was subtracted from the color optical density DA, and the obtained result was regarded as the color optical density difference ΔD before and after pressurization at 0.03 MPa.

### (Color Optical Density Uevenness in Condition of 0.05 MPa)

A color development region was formed in the developer layer in the second material in the same manner as in the measurement of the color optical density DA except for the fact that the pressure was changed from 0.03 MPa to 0.05 MPa. The pressure was changed by changing the weight of the weight.

The color development region formed in the developer layer in the second material was visually observed, and the color optical density unevenness in a condition of 0.05 MPa was evaluated according to the following evaluation standards.

In the following evaluation standards, the color optical density unevenness is further suppressed as the numerical values of evaluation ranks increases. The evaluation rank at which the color optical density unevenness is most suppressed is “5”.

### Evaluation Standards of Color Optical Density Unevenness in Condition of 0.05 MPa

5: There was no color optical density unevenness.

4: There was slight color optical density unevenness which was on a level of no practical problem.

3: There was color optical density unevenness which was on a level of no practical problem.

2: There was clear color optical density unevenness which might cause a practical difficulty.

1: There was severe color optical density unevenness, which was practically unavailable.

### (Color Development by Rubbing)

The first material and the second material were respectively cut to a 10 cm×15 cm size.

The cut first material and the cut second material were superimposed so that a surface of the color developer layer in the first material and a surface of the developer layer in the second material came into contact with each other.

The color developer layer and the developer layer were rubbed against each other by reciprocally moving the first material against the second material 20 times in the above-described state.

The developer layer in the second material after rubbing was visually observed, and color development by rubbing was evaluated according to the following evaluation standards.

In the following evaluation standards, color development by rubbing (that is, unintended color development) is further suppressed as the numerical values of evaluation ranks increases. The evaluation rank at which color development by rubbing is most suppressed is “5”.

### Evaluation Standards of Color Development by Rubbing

5: Color development in the developer layer in the second material was not recognized.

4: Color development in the developer layer in the second material was extremely slightly recognized, which was on a level of no practical problem.

3: Color development was observed in some of the developer layer in the second material, which was on a level of no practical problem.

2: Color development was observed in the majority of the developer layer in the second material, which was on a level with a practical problem.

1: Color development was observed on the entire surface of the developer layer in the second material, which was on a level with a practical problem.

### (Gradation Property of Color Development)

Color optical densities in the cases of applying individual pressures of 0.02 MPa, 0.03 MPa, 0.04 MPa, 0.05 MPa, and 0.06 MPa by changing the weight of the weight placed on the two glass plates in the above-described measurement of the color optical density DA were measured respectively.

On the basis of the measurement results, the gradation property of color development was evaluated according to the following evaluation standards.

In the following evaluation standards, the gradation property of color development becomes more favorable as the numerical values of evaluation ranks increases. The evaluation rank at which the gradation property of color development is most favorable is “5”.

### Evaluation Standards of Gradation Property of Color Development

5: A high color optical density was shown in a condition of 0.06 MPa, and an increase in the color optical density with an increase in the pressure was linear.

4: A high color optical density was shown in a condition of 0.06 MPa, and there were a small number of folding points in the increase in the color optical density with the increase in the pressure, which was on a level of no practical problem.

3: The density at 0.06 Mpa was low or the increase in the color optical density with the increase in the pressure in a pressure range of 0.04 MPa or lower was saturated, which was on a level of no practical problem.

2: The density at 0.06 Mpa was low or the increase in the color optical density with the increase in the pressure in a pressure range of 0.03 MPa or lower was saturated, which was on a level with a practical problem.

1: The density at 0.06 Mpa was near zero or the increase in the color optical density with the increase in the pressure was not shown, which was on a level with a practical problem.

### (Color Development Rate)

In the above-described measurement of the color optical density DA, the density of the color development region was measured every 30 seconds from the end of pressurization.

In a case where the above-described color optical density DA (that is, the color optical density 20 minutes after the end of pressurization) was set to 100%, a time taken to obtain a color optical density of 80% or more (that is, a time taken from the end of pressurization to the measurement of the density) was confirmed.

The color development rate becomes faster as the time taken to obtain the color optical density of 80% or more becomes shorter.

### (Color Optical Density After Storage (Relative Value))

The first material was stored for ten days in an environment of 45° C. and 70%RH. The same operation as that in a condition of 0.06 MPa regarding the above-described gradation property of color development was carried out using the first material after storage, and the density in the color development region of the developer layer (hereinafter, referred to as “color optical density DC”) was measured.

Regarding the color optical density DC, a relative value (%) of a case where the color optical density in a condition of 0.06 MPa regarding the above-described gradation property of color development was set to 100% was computed and regarded as the color optical density after storage (relative value).

### Example 2

The same operation as in Example 1 was carried out except for the fact that Ra of the surface of the developer layer was changed as shown in Table 1.

The results are shown in Table 1.

Ra of the surface of the developer layer was changed by changing the dispersion condition using the homogenizer (stirring rotating speed per unit time) in the preparation of the coating fluid for forming the developer layer.

Specifically, Ra of the surface of the developer layer increases as the stirring rotating speed per unit time becomes slower.

### Examples 3 and 4

In Examples 3 and 4 each, the same operation as in Examples 1 and 2 was carried out except for the fact that the proportion of the inorganic filler having a particle diameter of 0.1 μm or more in all of the inorganic filler in the first base material was changed as shown in Table 1 without changing the total content of the inorganic filler in the first base material.

The results are shown in Table 1.

Here, the proportion of the inorganic filler having a particle diameter of 0.1 μm or more in all of the inorganic filler in the first base material was adjusted by adjusting the ratio between the amounts of an inorganic filler A (amorphous silica particles, volume-average particle diameter: 0.02 μm) and an inorganic filler B (amorphous silica particles including amorphous silica particles having a particle diameter of 0.1 μm or more, volume-average particle diameter: 0.08 μm) used in the production of the first base material using the inorganic filler A and the inorganic filler B.

### Example 5

The same operation as in Example 2 was carried out except for the fact that the kind of the electron-accepting compound was changed as shown in Table 1.

The results are shown in Table 1.

The kind of the electron-accepting compound was changed by changing the coating fluid for forming the developer layer to the following coating fluid for forming the developer layer (Example 5).

### <Preparation of Coating Fluid for Forming Developer Layer (Example 5)>

A 40% sodium hydroxide aqueous solution (5 parts) and water (300 parts) were added to activated clay (100 parts) as a clay substance that is an electron-accepting compound, and the obtained liquid was dispersed using a homogenizer, thereby obtaining a dispersion liquid. A 10% aqueous solution of a sodium salt of casein (50 parts) and styrene-butadiene latex (30 parts as the solid content amount) were added to the obtained dispersion liquid, thereby obtaining a coating fluid for forming a developer layer containing the clay substance.

As the activated clay, “FURACOLOR SR” that is sulfate-treated activated clay manufactured by BYK Additives & Instruments was used.

### Example 6

The same operation as in Example 5 was carried out except for the fact that, in the preparation of the coating fluid for forming the color developer layer, two kinds of microcapsule A-containing liquids (specifically, a microcapsule A1-containing liquid and a microcapsule A2-containing liquid) were used.

The results are shown in Table 1.

The amount of the microcapsule A1-containing liquid added and the amount of the microcapsule A2-containing liquid added were set to an amount at which the mass ratio of a microcapsule A1 to a microcapsule A2 in the color developer layer (hereinafter, regarded as “A1/A2 mass ratio”) reached a value shown in Table 1.

The total amount of the amount of the microcapsule A1-containing liquid added and the amount of the microcapsule A2-containing liquid added in Example 6 was set to be the same as the amount of the microcapsule A1-containing liquid added in Example 1.

In Example 6, the microcapsule A1-containing liquid included the microcapsule A1 having DSOA and a wall thickness shown in Table 1, and the microcapsule A2-containing liquid included the microcapsule A2 having D50A and a wall thickness shown in Table 1.

The microcapsule A1-containing liquid and the microcapsule A2-containing liquid were both prepared in the same manner as the microcapsule A1-containing liquid included the microcapsule A having D50A and a wall in Example 5. The D50A and wall thickness of the microcapsule A were changed as shown in Table 1 by changing the stirring rotating speed per unit time during the emulsification and dispersion in the preparation of the microcapsule A1-containing liquid in Example 5.

Specifically, as the stirring rotating speed per unit time decreases, D50A of the microcapsule A increases, and the wall thickness of the microcapsule A becomes thicker.

### Examples 7 and 8

The same operation as in Example 5 was carried out except for the fact that the CV value of the particle size distribution of the color developer layer was changed as shown in Table 1.

The results are shown in Table 1.

The CV value of the particle size distribution of the color developer layer was changed by changing the stirring time during the emulsification and dispersion.

Specifically, the CV value of the particle size distribution of the color developer layer increases as the stirring time becomes shorter.

### Example 9

The same operation as in Example 6 was carried out except for the fact that, in the preparation of the coating fluid for fonning the color developer layer, furthermore, the following microcapsule B1-containing liquid containing the microcapsule B1 as the microcapsule B not encapsulating an electron-donating dye precursor was added thereto.

The results are shown in Table 1.

The amount of the microcapsule B1-containing liquid added was set to an amount at which the mass ratio of the microcapsule B1 to the total of the microcapsule A1 and the microcapsule A2 in the color developer layer (hereinafter, also referred to as “B1/(A1+A2) mass ratio”) reached a value shown in Table 1.

### Preparation of Microcapsule B1-Containing Liquid

Synthetic isoparaffin (Idemitsu Kosan Co., Ltd., IP SOLVENT 1620) (15 parts) and N,N,N′,N′-tetrakis(2-hydroxypropyl)ethylene diamine (ADEKA Corporation, ADEKA POLYETHER EDP-300) dissolved in ethyl acetate (3 parts) (0.4 parts) were added to 1-phenyl-1-xylyl ethane (manufactured by Nippon Oil Corporation, HISOL SAS296) (78 parts) under stirring, thereby obtaining a solution X.

The obtained solution X was stirred, and a trimethylolpropane adduct of torylene diisocyanate (DIC Corporation, BURNOCK D-750) dissolved in ethyl acetate (7 parts) (3 parts) was added thereto, thereby obtaining a solution Y.

Next, the solution Y was added to a solution obtained by dissolving polyvinyl alcohol (PVA-205, Kuraray Co., Ltd.) (9 parts) in water (140 parts), emulsified, and dispersed. Water (340 parts) was added to the obtained emulsified liquid, heated up to 70° C. under stirring, stirred for one hour, and then cooled. Water was further added to the cooled liquid, thereby adjusting the concentration of the solid content.

A microcapsule B1-containing liquid containing a microcapsule B1 as the microcapsule B not encapsulating an electron-donating dye precursor (concentration of solid content: 19.6%) was obtained in the above-described manner.

For the microcapsule B1 that was contained in the microcapsule B 1-containing liquid, the volume-based median size (hereinafter, also referred to as “D50B”) and the wall thickness were values shown in Table 1.

Methods for measuring the D50B and wall thickness of the microcapsule B1 were respectively set to be the same as the methods for measuring the D50A and wall thickness of the microcapsule A1.

In addition, a wall material of the microcapsule B1 was, as shown in Table 1, PUR (that is, a urethane-urea resin).

### Examples 10 and 11

The same operation as in Example 9 was carried out except for the fact that Ra of the surface of the developer layer was changed as shown in Table 1.

The results are shown in Table 1.

Ra of the surface of the developer layer was changed by changing the dispersion condition (stirring rotating speed per unit time) using a homogenizer in the preparation of the coating fluid for forming the developer layer.

Specifically, Ra of the surface of the developer layer increases as the stirring rotating speed per unit time becomes slower.

### Example 12

The same operation as in Example 9 was carried out except for the fact that the proportion of the inorganic filler having a particle diameter of 0.1 μm or more in all of the inorganic filler in the first base material was changed as shown in Table 1 without changing the total content of the inorganic filler in the first base material.

The results are shown in Table 1.

The proportion of the inorganic filler having a particle diameter of 0.1 μm or more in all of the inorganic filler in the first base material was adjusted in the same manner as in Example 3.

### Example 13

The same operation as in Example 5 was carried out except for the fact that the microcapsule A1-containing liquid was changed to the following microcapsule A1-containing liquid (Example 13).

The results are shown in Table 1.

### <Preparation of Microcapsule A1-Containing Liquid (Example 13)

A partial sodium salt of polyvinyl sulfonic acid (average molecular weight: 500,000) (10 parts) was added to and dissolved in hot water (80° C., 140 parts) under stirring, and then cooled, thereby obtaining an aqueous solution M1. The pH of this aqueous solution M1 was two to three. A 20% by mass sodium hydroxide aqueous solution was added to the aqueous solution M1, and the pH was adjusted to 4.0, thereby obtaining an aqueous solution M2.

Separately, a solution B2 (that is, a solution including the compound (A) that is an electron-donating dye precursor) was prepared in the same manner as the solution B in the preparation of the microcapsule A1-containing liquid in Example 1. Here, the amount of the solution B2 prepared was also set to be the same as the amount of the solution B prepared in Example 1.

The solution B2 was added to the aqueous solution M2, emulsified, and dispersed, thereby obtaining an emulsified liquid M3.

Separately, melamine (6 parts) and a 37% by mass formaldehyde aqueous solution (11 parts) were heated to 60° C. and stirred at this temperature for 30 minutes, thereby obtaining a mixed aqueous solution M4 (pH 6 to 8) including melamine, formaldehyde, and a melamine-formaldehyde initial condensate.

Next, the emulsified liquid M3 and the mixed aqueous solution M4 were mixed together, the pH of a liquid was adjusted to 6.0 using a 3.6% by mass hydrochloric acid solution while stirring the obtained liquid, subsequently, the liquid temperature was increased to 65° C., and the liquid was continuously stirred at this temperature for 360 minutes. The stirred liquid was cooled, and then the pH of the liquid was adjusted to 9.0 using a sodium hydroxide aqueous solution.

A microcapsule A1-containing liquid (Example 13) which contained a microcapsule A1 as the microcapsule A encapsulating an electron-donating dye precursor (pH: 9.0, concentration of solid content: 19.6%) was obtained in the above-described manner.

For the microcapsule A1 that was contained in the microcapsule A1-containing liquid of Example 13, D50A and the wall thickness were values shown in Table 1.

Methods for measuring the D50A and wall thickness of the microcapsule A1 were as described above.

In addition, a wall material of the microcapsule A1 of Example 13 was, as shown in Table 1, a melamine formaldehyde resin (hereinafter, also referred to as “MF”).

### Example 14

The same operation as in Example 13 was carried out except for the fact that, in the preparation of the coating fluid for forming the color developer layer, two kinds of microcapsule A-containing liquids (specifically, a microcapsule A1-containing liquid and a microcapsule A2-containing liquid) were used.

The results are shown in Table 1.

The amount of the microcapsule A1-containing liquid added and the amount of the microcapsule A2-containing liquid added were set to an amount at which the mass ratio of a microcapsule A1 to a microcapsule A2 in the color developer layer (hereinafter, regarded as “A1/A2 mass ratio”) reached a value shown in Table 1.

The total amount of the amount of the microcapsule A1-containing liquid added and the amount of the microcapsule A2-containing liquid added in Example 14 was set to be the same as the amount of the microcapsule A1-containing liquid added in Example 13.

In Example 14, the microcapsule A2-containing liquid included the microcapsule A1 having D50A and a wall thickness shown in Table 1, and the microcapsule A2-containing liquid included the microcapsule A2 having D50A and a wall thickness shown in Table 1.

The microcapsule A1-containing liquid and the microcapsule A2-containing liquid were both prepared in the same manner as the microcapsule A1-containing liquid in Example 13. The D50A and wall thickness of the microcapsule A were changed as shown in Table 1 by changing the stirring rotating speed per unit time during the emulsification and dispersion in the preparation of the microcapsule A1-containing liquid in Example 13.

Specifically, as the stirring rotating speed per unit time decreases, D50A of the microcapsule A increases, and the wall thickness of the microcapsule A becomes thicker.

### Example 15

The same operation as in Example 14 was carried out except for the fact that, in the preparation of the coating fluid for forming the color developer layer, furthermore, the following “microcapsule B1-containing liquid in Example 15” which contained a microcapsule B1 as the microcapsule B not encapsulating an electron-donating dye precursor was added thereto.

The results are shown in Table 1.

The amount of the microcapsule B1-containing liquid in Example 15 added was set to an amount at which the B1/(A1+A2) mass ratio in the color developer layer reached a value shown in Table 1.

### <Preparation of Microcapsule B1-Containing Liquid in Example 15

The microcapsule B1-containing liquid in Example 15 which contained a microcapsule B1 as the microcapsule B not encapsulating an electron-donating dye precursor was prepared in the same manner as in the preparation of the microcapsule A1-containing liquid in Example 13 except for the fact that the solution B2 (that is, a solution including the compound (A) that is an electron-donating dye precursor) was changed to a solution X2 (that is, a solution not including an electron-donating dye precursor) which is the same solution as the solution X in Example 9. Here, the amount of the solution X2 used was set to be the same as the amount of the solution X prepared in Example 9.

For the microcapsule B1 that was contained in the microcapsule B1-containing liquid of Example 15, D50B and the wall thickness were values shown in Table 1.

Methods for measuring the D50B and wall thickness of the microcapsule B1 were respectively set to be the same as the methods for measuring the D50A and wall thickness of the microcapsule A1.

In addition, a wall material of the microcapsule B1 was, as shown in Table 1, a melamine formaldehyde resin (hereinafter, also referred as “MF”).

### Comparative Examples 1 and 2

The same operation as in Examples 2 and 5 was carried out except for the fact that the proportion of the inorganic filler having a particle diameter of 0.1 μm or more in all of the inorganic filler in the first base material was changed as shown in Table 1 without changing the total content of the inorganic filler in the first base material.

The results are shown in Table 1.

The proportion of the inorganic filler having a particle diameter of 0.1 μm or more in all of the inorganic filler in the first base material was adjusted by adjusting the ratio between the amounts of the inorganic filler A (amorphous silica particles, volume-average particle diameter: 0.02 μm) and the inorganic filler B (amorphous silica particles including amorphous silica particles having a particle diameter of 0.1 μm or more, volume-average particle diameter: 0.08 μm) used in the production of the first base material using the inorganic filler A and the inorganic filler B.

### Comparative Example 3

The same operation as in Example 5 was carried out except for the fact that Ra of the surface of the developer layer was changed as shown in Table 1.

The results are shown in Table 1.

Ra of the surface of the developer layer was changed by changing the dispersion condition of activated clay by a homogenizer in the preparation of the coating fluid for forming the developer layer.

TABLE 1

| | First material | | | | | | | | | | | |
|---|---|---|---|---|---|---|---|---|---|---|---|---|
| | Color developer layer | | | | | | | | | | | |
| | Microcapsule A | | | | | | Microcapsule B | | | | | |
| | A1 | | | A2 | | | B1 | | | | | CV value |
| | | Wall | | | Wall | | | Wall | | | | of particle |
| | D50A | thickness | Wall | D50A | thickness | Wall | D50A | thickness | Wall | A1/A2 | B1/(A1 + A2) | size |
| | (μm) | (nm) | material | (μm) | (nm) | material | (μm) | (nm) | material | mass ratio | mass ratio | distribution |
| Example 1 | 25 | 58 | PUR | — | — | — | — | — | — | — | — | 65% |
| Example 2 | 25 | 58 | PUR | — | — | — | — | — | — | — | — | 65% |
| Example 3 | 25 | 58 | PUR | — | — | — | — | — | — | — | — | 65% |
| Example 4 | 25 | 58 | PUR | — | — | — | — | — | — | — | — | 65% |
| Example 5 | 25 | 58 | PUR | — | — | — | — | — | — | — | — | 65% |
| Example 6 | 30 | 70 | PUR | 15 | 35 | PUR | — | — | — | 60/40 | — | 70% |
| Example 7 | 25 | 58 | PUR | — | — | — | — | — | — | — | — | 53% |
| Example 8 | 25 | 58 | PUR | — | — | — | — | — | — | — | — | 90% |
| Example 9 | 30 | 70 | PUR | 15 | 35 | PUR | 60 | 125 | PUR | 60/40 | 20/100 | 75% |
| Example 10 | 30 | 70 | PUR | 15 | 35 | PUR | 60 | 125 | PUR | 60/40 | 20/100 | 75% |
| Example 11 | 30 | 70 | PUR | 15 | 35 | PUR | 60 | 125 | PUR | 60/40 | 20/100 | 75% |
| Example 12 | 30 | 70 | PUR | 15 | 35 | PUR | 60 | 125 | PUR | 60/40 | 20/100 | 75% |
| Example 13 | 25 | 58 | MF | — | — | — | — | — | — | — | — | 65% |
| Example 14 | 30 | 70 | MF | 15 | 35 | MF | — | — | — | 60/40 | — | 70% |
| Example 15 | 30 | 70 | MF | 15 | 35 | MF | 60 | 125 | MF | 60/40 | 20/100 | 75% |
| Comparative | 25 | 58 | PUR | — | — | — | — | — | — | — | — | 65% |
| Example 1 | | | | | | | | | | | | |
| Comparative | 25 | 58 | PUR | — | — | — | — | — | — | — | — | 65% |
| Example 2 | | | | | | | | | | | | |
| Comparative | 25 | 58 | PUR | — | — | — | — | — | — | — | — | 65% |
| Example 3 | | | | | | | | | | | | |

| | First material | | | | | | | | | |
|---|---|---|---|---|---|---|---|---|---|---|
| | First base | | | | | | | | | |
| | material | | | Evaluation | | | | | | |
| | Proportion of | | | | Color | | | | | |
| | filler having | | | | optical | | | | | Color |
| | particle | | | | density | | | | | optical |
| | diameter of | | | | unevenness | | | | | density |
| | 0.1 μm or | Second material | | ΔD in | in | | Gradation | | | after |
| | more in all | Developer layer | | condition | condition | Color | property of | Color | | storage |
| | filler (% by | Electron-accepting | Ra | of 0.03 | of 0.05 | development | color | development | | (absolute |
| | volume) | compound | (μm) | MPa | MPa | by rubbing | development | rate | | value) |
| Example 1 | 0 | Zinc salicylate | 0.4 | 0.08 | 5 | 4 | 4 | 2 | minutes | 80% |
| Example 2 | 0 | Zinc salicylate | 0.7 | 0.10 | 5 | 4 | 4 | 2 | minutes | 80% |
| Example 3 | 3 | Zinc salicylate | 0.4 | 0.10 | 4 | 4 | 4 | 2 | minutes | 80% |
| Example 4 | 3 | Zinc salicylate | 0.7 | 0.12 | 4 | 4 | 4 | 2 | minutes | 80% |
| Example 5 | 0 | Activated clay | 0.7 | 0.12 | 5 | 4 | 4 | 30 | seconds | 80% |
| Example 6 | 0 | Activated clay | 0.7 | 0.12 | 5 | 4 | 5 | 30 | seconds | 80% |
| Example 7 | 0 | Activated clay | 0.7 | 0.14 | 5 | 4 | 3 | 30 | seconds | 80% |
| Example 8 | 0 | Activated clay | 0.7 | 0.08 | 5 | 4 | 3 | 30 | seconds | 80% |
| Example 9 | 0 | Activated clay | 0.7 | 0.16 | 5 | 5 | 5 | 30 | seconds | 80% |
| Example 10 | 0 | Activated clay | 0.4 | 0.14 | 5 | 5 | 5 | 30 | seconds | 80% |
| Example 11 | 0 | Activated clay | 1.0 | 0.18 | 4 | 4 | 5 | 30 | seconds | 80% |
| Example 12 | 3 | Activated clay | 0.7 | 0.18 | 4 | 5 | 5 | 30 | seconds | 80% |
| Example 13 | 0 | Activated clay | 0.7 | 0.12 | 4 | 4 | 4 | 30 | seconds | 90% |
| Example 14 | 0 | Activated clay | 0.7 | 0.12 | 4 | 4 | 5 | 30 | seconds | 90% |
| Example 15 | 0 | Activated clay | 0.7 | 0.16 | 4 | 5 | 5 | 30 | seconds | 90% |
| Comparative | 8 | Zinc salicylate | 0.7 | 0.14 | 2 | 5 | 2 | 2 | minutes | 80% |
| Example 1 | | | | | | | | | | |
| Comparative | 8 | Activated clay | 0.7 | 0.14 | 2 | 5 | 2 | 30 | seconds | 80% |
| Example 2 | | | | | | | | | | |
| Comparative | 0 | Activated clay | 1.3 | 0.20 | 2 | 4 | 3 | 30 | seconds | 80% |
| Example 3 | | | | | | | | | | |

As shown in Table 1, in Examples 1 to 15 for which the material for pressure measurement including the first material having the color developer layer containing the microcapsule A encapsulating an electron-donating dye precursor disposed on the first base material and the second material having the developer layer containing an electron-accepting compound disposed on the second base material, in which the first base material contains the inorganic filler, the proportion of the inorganic filler having a particle diameter of 0.1 μin or more in all of the inorganic filler contained in the first base material is 5% by volume or less, and the arithmetic average roughness Ra of the surface of the developer layer satisfies 0.1 μm≤Ra≤1.1 μm, was used, the color optical density difference ΔD before and after pressurization at 0.03 MPa was large to a certain extent (that is, a color optical density that could be read at a pressure of 0.05 MPa or lower could be obtained), and color optical density unevenness in a condition of 0.05 MPa was suppressed.

In Examples 1 to 15 and Comparative Examples 1 to 3, Ra's of the surfaces of the color developer layers were measured in the same manner as Ra's of the surfaces of the developer layers and found out to be in a range of 1.5 μm to 2.8 μm in Examples 1 to 15 and Comparative Example 3 and be more than 3.0 μm in Comparative Examples 1 and 2.

In contrast to Examples 1 to 15, in Comparative Examples 1 and 2 in which the proportion of an inorganic filler having a particle diameter of 0.1 μm or more in all of the inorganic filler contained in the first base material was more than 5% by volume and Comparative Example 3 in which the arithmetic average roughness Ra of the surface of the developer layer was more than 1.1 μm, the color optical density unevenness in a condition of 0.05 MPa deteriorated.

From the comparison between Examples 7 and 8 and other examples, it is found that, in a case where the CV value of the particle size distribution of the color developer layer (that is, the coefficient of variation of the volume-based particle size distribution of particles having a particle diameter of 2 μm or more contained in the color developer layer) is 60% to 80%, the gradation property of color development further improves.

From the comparison between Examples 9, 10, 12, and 15 and other examples, it is found that, in a case where the color developer layer contains the microcapsule B not encapsulating an electron-donating dye precursor, color development by rubbing is further suppressed.

In addition, from the comparison between Examples 13 to 15 and other examples, it is found that, in a case where the wall materials of the microcapsule A and/or the microcapsule B (that is, the material of the capsule wall) is MF (that is, a melamine formaldehyde resin), the color optical density after storage is maintained on a high level.

The disclosure of Japanese Patent Application No. 2017-108377 filed on May 31, 2017 is all incorporated into the present specification by reference.

All of documents, patent applications, and technical standards described in the present specification are incorporated into the present specification by reference to approximately the same extent as a case where it is specifically and respectively described that the respective documents, patent applications, and technical standards are incorporated by reference.

What is claimed is:

1. A material for pressure measurement comprising:
a first material having a color developer layer containing a microcapsule A encapsulating an electron-donating dye precursor disposed on a first base material; and
a second material having a developer layer containing an electron-accepting compound disposed on a second base material,
wherein the first base material contains an inorganic filler, and a proportion of the inorganic filler having a particle diameter of 0.1 μm or more in the inorganic filler contained in the first base material is 5% by volume or less, and
an arithmetic average roughness Ra of a surface of the developer layer satisfies 0.1 μm≤Ra≤1.1

2. The material for pressure measurement according to claim 1,
wherein the color developer layer is adjacent to the first base material.

3. The material for pressure measurement according to claim 1,
wherein a coefficient of variation of a number-based particle size distribution of particles having a particle diameter of 2 μm or larger contained in the color developer layer is 50% to 100%.

4. The material for pressure measurement according to claim 3,
wherein the color developer layer is adjacent to the first base material.

5. The material for pressure measurement according to claim 1,
wherein at least one of the color developer layer or the developer layer contains a microcapsule B not encapsulating the electron-donating dye precursor.

6. The material for pressure measurement according to claim 1,
wherein the color developer layer contains a microcapsule B not encapsulating the electron-donating dye precursor.

7. The material for pressure measurement according to claim 4,
wherein the color developer layer contains a microcapsule B not encapsulating the electron-donating dye precursor.

8. The material for pressure measurement according to claim 5,
wherein a material of a capsule wall of the microcapsule B is a melamine formaldehyde resin.

9. The material for pressure measurement according to claim 1,
wherein a material of a capsule wall of the microcapsule A is a melamine formaldehyde resin.

10. The material for pressure measurement according to claim 7,
wherein a material of a capsule wall of each of the microcapsule A and the microcapsule B is a melamine formaldehyde resin.

11. The material for pressure measurement according to claim 1,
wherein a color optical density difference ΔD before and after pressurization at 0.03 MPa is 0.08 or more.

12. The material for pressure measurement according to claim 1,
wherein the proportion of the inorganic filler having a particle diameter of 0.1 μm or more in all of the inorganic filler contained in the first base material is 2% by volume or less.

13. The material for pressure measurement according to claim 12,
wherein a color optical density difference ΔD before and after pressurization at 0.03 MPa is 0.08 or more.

14. The material for pressure measurement according to claim 1,
wherein the electron-accepting compound is a clay substance that is at least one selected from the group consisting of acid clay, activated clay, attapulgite, zeolite, bentonite and kaolin.

15. The material for pressure measurement according to claim 10,
wherein the electron-accepting compound is a clay substance that is at least one selected from the group consisting of acid clay, activated clay, attapulgite, zeolite, bentonite and kaolin.

16. The material for pressure measurement according to claim 13,
wherein the electron-accepting compound is a clay substance that is at least one selected from the group consisting of acid clay, activated clay, attapulgite, zeolite, bentonite and kaolin.

17. The material for pressure measurement according to claim 1,
wherein a total content of the inorganic filler contained in the first base material is 0.005% by mass to 5% by mass of a total amount of the first base material.

18. The material for pressure measurement according to claim 10,
wherein a total content of the inorganic filler contained in the first base material is 0.005% by mass to 5% by mass of a total amount of the first base material.

19. The material for pressure measurement according to claim 16,
wherein a total content of the inorganic filler contained in the first base material is 0.005% by mass to 5% by mass of a total amount of the first base material.
